(19) United States
(12) Patent Application Publication
(10) Pub. No.: US 2010/0225149 A1
(43) Pub. Date: Sep. 9, 2010

(54) Head support apparatus for child car seats

(76) Inventor: Sharon Noah, Hanford, CA (US)

Correspondence Address: RICHARD A. RYAN;ATTORNEY AT LAW, 8497 N. MILLBROOK AVENUE, SUITE 101, FRESNO, CA, 93720, US

(21) Appl. No.: 12/381,103

(22) Filed: Mar. 6, 2009

(51) Int. Cl. B60N 2/42

(52) U.S. Cl. 297/216.12

(57) ABSTRACT

A head support apparatus for use with child car seats to prevent a child's head from loosely swinging forward and side to side as a result of the movement of a vehicle, particularly when the child is asleep. In a preferred configuration, the apparatus comprises a head device that is received on or around the head of the child, a harness assembly that attaches the apparatus to the car seat and an attachment mechanism that removably attaches the head device to the harness assembly. Preferably, the head device is a cap, beanie, headband or other hat-like object. The preferred harness assembly has a pair of longitudinal straps that are received through slots in the back wall of the car seat body and a lateral strap that is movably engaged with the longitudinal straps and configured to attach to the head device. The attachment mechanism can be a hook-and-loop connector.

### CROSS-REFERENCE TO RELATED APPLICATIONS

None.

### STATEMENT REGARDING FEDERALLY SPONSORED RESEARCH

Not Applicable.

### BACKGROUND OF THE INVENTION

A. Field of the Invention

The field of the present invention relates generally to apparatuses for safely securing a child in a moving vehicle. In particular, the present invention relates to such apparatuses that are configured to be utilized with a child car seat to safely and comfortably secure the child in the car seat in the moving vehicle. Even more particularly, the present invention relates to such apparatuses that reduce or substantially eliminate undesirable movement of the child's head.

B. Background

The use of child car seats to safely secure infants and small children in a moving vehicle is well known in the prior art. In fact, most states mandate that children under a certain weight and/or height must be secured in a specially configured car seat. Approved car seats are designed to restrain the child in the event the vehicle in which he or she is riding rapidly decelerates, suddenly stops or is involved in an accident or other impact event that would otherwise cause an unsecured child to impact the inside of the vehicle and be injured or killed. The typical car seat includes a body portion that is secured to a seat in the vehicle and a harness system that secures the child to the car seat. The body portion has back, bottom and side walls that are dimensioned to receive the child in an upright, outwardly facing position. Harness systems typically comprise a plurality of straps that define a shoulder portion which is placed over the child's shoulders and secured together near his or her chest and a waist or lower body portion that engages the child's pelvis area, often between the child's legs, and is joined to the shoulder portion. The car seat harness system locks to secure the child in the car seat and prevent the child from being ejected from the car seat. Many car seats also comprise a safety bar that is pivotally attached to the body portion so it can be pivoted upward to place a child in or remove a child from the car seat and pivoted downward and locked into position to secure the child in the car seat.

Although child car seats perform well with regard to restraining a child in a vehicle, it is generally well known that conventional car seats do not provide much, if any, support for the child's head or neck. It is also well known that children tend to fall asleep in car seats when the vehicle is moving. When this happens, the child's head will typically sag, droop or otherwise hang forward or lay to his or her side. Prolonged hanging of the head is known to be relatively uncomfortable and can result in a sore neck. The lack of support for the child's head can also cause the child to wake prematurely and frequently, typically resulting in an unhappy child that someone, often the driver, must either ignore or address, usually by stopping the vehicle. A child falling asleep or between being awake and asleep will tend to swing his or her head between the forward and side to side positions, causing even more discomfort and neck soreness. As the vehicle moves, particularly around corners, the swinging of the child's head is further exasperated, usually significantly increasing the problems associated with a lack of head/neck support in child car seats. Typically, someone in the vehicle will adjust the child's position in an attempt to lessen the swinging, often by laying the child's head against one of the sides of the car seat or by placing a towel or other soft support alongside the child's head. Naturally, if the only other person in the vehicle is the driver, then he or she must stop the vehicle make the necessary adjustments to the child's position.

A variety of prior art apparatuses have been proposed in an attempt to solve the problems associated with a lack of head/neck support in child car seats. Many of these prior art apparatuses have drawbacks that have generally limited their acceptance, including undesired restriction of the child's shoulders, arms and/or head, restriction of vision, lack of adjustability, incompatibility with some of the available car seats and difficultly with cleaning. In addition, many of the prior art apparatuses provide little or no frontal head support, thereby not solving the problems associated with the child's head hanging forward. Some of the prior art apparatuses are primarily configured for infants and, as such, are generally incompatible with toddlers. Other prior art apparatuses have a portion that encircles the neck, which could be uncomfortable and may be dangerous for the child, particularly in a rapid deceleration event.

A number of prior art devices have been patented. As an example of the prior art, U.S. Pat. No. 6,789,851 to Smith discloses a sleep collar that comprises a pair of collar supports, preferably tubular and stuffed with cushion fill material, which attach to the car seat on opposite sides of the child's head and envelope around the child's neck to provide support as the child lays against the collar supports. U.S. Pat. No. 7,490,909 to Haggman, et al. discloses a reversible head rest for vehicle infant car seats that comprises a pillow having a generally L-shaped body that is attached at its longitudinal region to the side and back of the car seat in a manner that leaves the latitudinal edge free to bias towards and away from the back rest as needed to support the child's head. U.S. Pat. No. 6,266,832 to Ezell discloses an infant cranial support system for use with infant car seats comprising a first toroidal cushion configured to receive the posterior region of the infant's skull and a second toroidal cushion configured to encircle the infant's neck to cushion against lateral and forward motion of the head. U.S. Pat. No. 6,758,526 to Marbutt discloses a child's headrest having a base pad that receives the child's head and is placed over the back of the seat and a pair of side cushions connected to the base pad that run alongside the child's temples, cheeks and shoulders to interconnect under the child's chin. U.S. Pat. No. 6,793,287 to Dunk discloses a booster seat head rest that comprises a harness assembly and, preferably, a pair of pillows attached to and suspended from the harness assembly to lay on either side of the child so he or she may lean his or her head against one of the pillows.

As stated above, the prior art devices either do not sufficiently solve the problem of the child's head swinging in the car seat or do so in a manner that has not been widely accepted. What is needed, therefore, is an improved head support apparatus for child car seats that effectively supports the child's head and neck while he or she is in the car seat so as to reduce or substantially eliminate the swinging movement of the head and the uncomfortableness and soreness that typically results. The preferred apparatus should be easily adapted for use with a variety of different types of car seats and for children of different sizes. In addition, the preferred apparatus should be easy to install and easy to remove from conventionally configured child car seats. Preferably, the apparatus should be suitable for customization by the user. The preferred apparatus should be easy to clean and relatively inexpensive to manufacture.

### SUMMARY OF THE INVENTION

The head support apparatus of the present invention solves the problems and provides the benefits identified above. That is to say, the present invention discloses a head support apparatus that is utilized with a child car seat to effectively support a child's head and neck while in the car seat in a manner that reduces or substantially eliminates swinging movement of the child's head. As such, the head support apparatus of the present invention is more comfortable for the child and substantially reduces the soreness that typically results from a child falling asleep in the car seat. In a preferred configuration, the head support apparatus is configured for use with a variety of different child car seats and with children of different sizes. The preferred configuration of head support apparatus can be easily and quickly installed on and removed from a conventional child car seat, allowing the user to move the apparatus from one car seat to another and remove/reinstall the apparatus for cleaning. In a preferred configuration, the head support apparatus is simple to adjust for the size and comfort of the child. If desired, a parent or other user can easily customize the head support apparatus of the present invention according to his or her own tastes. In the preferred embodiment, the head support apparatus is inexpensive to manufacture.

In a primary embodiment of the present invention, the head support apparatus for use with a child car seat generally comprises a head device that fits onto or around the child's head, a harness assembly that secures the apparatus to the car seat and an attachment means that removably attaches the head device to the harness assembly. The head device can be a baseball cap, beanie, headband or other hat-like object. Preferably, the head device is adjustable in size to accommodate growth of the child or use of the apparatus with a different sized child. The preferred configuration of the harness assembly comprises a pair of longitudinal strap members that removably connect to the car seat by passing through a pair of slots in the back wall of the body portion of the car seat and a lateral strap member which interconnects the pair of longitudinal strap members. Preferably, the head device removably connects to the lateral strap member and the lateral strap member is movably connected at its ends to the longitudinal strap members so that it can slide up and down the longitudinal strap members to adjust the position of the head device for the size of the child using the apparatus. In a preferred embodiment, the lateral strap member has loops at its ends that each slidably receive one of the longitudinal strap members therein. The longitudinal strap members can be fixedly attached to the car seat body or have a connecting means, such as a hook-and-loop connector or the like, that allows the user to remove the harness assembly for cleaning or replacement. The preferred attachment means for attaching the head device to the harness assembly is also a hook-and-loop connector. In use, the harness assembly is installed on the car seat with the attachment means on the lateral strap member facing away from the back wall of the car seat, the lateral strap member is moved into the approximate position of the child's head, the child is placed into the car seat, the hat or other head device is placed on the child, the head device is attached to the harness assembly and the lateral strap member is then moved as necessary to a position behind the child's head. If desired, the head device can be attached to the harness assembly before the child is placed in the car seat. In an alternative embodiment, the attachment means removably attaches the head device directly to the car seat body or to the cover over the car seat body, thereby eliminating the need for the harness assembly.

Accordingly, one of the primary aspects of the present invention is to provide a head support apparatus for child car seats that has the advantages discussed above and overcomes the disadvantages and limitations associated with presently available child car seat head support apparatuses.

It is an important aspect of the present invention to provide a head support apparatus that is configured for use with a child car seat to reduce or substantially eliminate the problems associated with a child's head swinging freely in the car seat when the child is asleep.

It is also an important aspect of the present invention to provide a head support apparatus for child car seats that is adaptable for use with a variety of different types of car seats and for different sizes of children.

It is also an important aspect of the present invention to provide a head support apparatus for child car seats that is easy to install on and remove from a conventional car seat, thereby allowing the user to easily and quickly move the apparatus from one car seat to another and/or remove and reinstall the apparatus for cleaning.

Another important aspect of the present invention is to provide a head support apparatus for child car seats that can be customized according to the user's own tastes.

Yet another important aspect of the present invention is to provide a head support apparatus for child car seats that, in a preferred embodiment, is relatively inexpensive to manufacture and easy to use.

The above and other aspects and advantages of the present invention are explained in greater detail by reference to the attached figures and the description of the preferred embodiment which follows. As set forth herein, the present invention resides in the novel features of form, construction, mode of operation and combination of the above presently described and understood by the claims.

### BRIEF DESCRIPTION OF THE DRAWINGS

In the drawings which illustrate the preferred embodiments and the best modes presently contemplated for carrying out the present invention:

FIG. 1 is a front view of a conventional prior art car seat;

FIG. 2 is a front view of a head support apparatus that is configured according to a preferred embodiment of the present invention shown in use with a child sitting in the car seat of FIG. 1 and a hat as the head device;

FIG. 3 is a back view of the prior art car seat of FIG. 1 shown with the head support apparatus of the present invention attached thereto;

FIG. 4 is a front view of the prior art car seat of FIG. 1 shown with the head support apparatus of the present invention attached thereto with the head device thereof removed to better illustrate the harness assembly of the head support apparatus;

FIG. 5 is an exploded view of a preferred embodiment of the head support apparatus of the present invention;

FIG. 6 is an isolated portion of the back of a child car seat having the head support apparatus of the present invention showing one of the strap members in a disconnected condition and the other strap member in a connected condition to better illustrate the connecting means utilized therewith;

FIG. 7 is an alternative embodiment of the head support apparatus of the present invention showing a front view of a modified harness assembly and a rear view of a headband as the head device configured for attachment to the harness assembly; and

FIG. 8 is an alternative embodiment of the head support apparatus of the present invention showing a front view of a prior art car seat with the attachment means directly mounted on the car seat and a rear view of a beanie as the head device configured for attachment to the car seat.

### DETAILED DESCRIPTION OF THE PREFERRED EMBODIMENTS

With reference to the figures where like elements have been given like numerical designations to facilitate the reader's understanding of the present invention, the preferred embodiments of the present invention are set forth below. The enclosed text and drawings are merely illustrative of one or more preferred embodiments and, as such, disclose one or more different ways of configuring the present invention. Although specific components, materials, configurations and uses are illustrated, it should be understood that a number of variations to the components and to the configuration of those components described herein and in the accompanying figures can be made without changing the scope and function of the invention set forth herein. For instance, although the figures and description provided herein show certain configurations for the components of the head support apparatus, those skilled in the art will readily understand that this is merely for purposes of simplifying the present disclosure and that the present invention is not so limited.

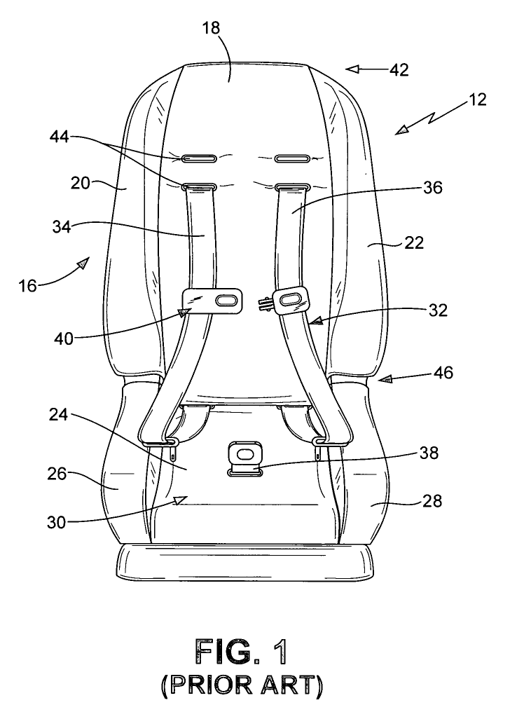

A head support apparatus that is configured pursuant to a preferred embodiment of the present invention is identified generally as 10 in the figures. The head support apparatus 10 is configured for use with a conventional child car seat 12, such as shown in FIGS. 1, 2 and 3, that is utilized to safely secure a child 14 in a moving vehicle (not shown). As is well known in the art of child car seats, a conventional car seat 12 has a body portion 16 comprising a back wall 18 interconnecting a pair of spaced apart upper side walls 20/22 and a lower wall 24 interconnecting a pair of spaced apart lower side walls 26/28 that, together, define the seating area 30 where the child 14 sits and a securing assembly 32 comprising a pair of shoulder straps 34 and 36, a lap strap 38 and a locking mechanism 40 that lockingly joins the shoulder 34/36 and lap 38 straps to secure the child 14 to the car seat 12. Typically, body portion 16 is made out of a hard plastic or other relatively lightweight and strong material, which is usually covered with a soft cloth or cloth-like material for the comfort of the child 14 sitting in car seat 12, and shoulder 34/36 and lap 38 straps are made out of a generally inelastic material. In use, the car seat 12 is secured inside the vehicle, typically to one of the seats in the vehicle. The upper end 42 of back wall 18 has one or more pairs of slots 44, usually a plurality, that the shoulder straps 34/36 pass through. The user of car seat 12 selects the pair of slots 44 to utilize based on the size of the child 14, with a larger child typically requiring use of the slots 44 disposed closer to upper end 42 of back wall 18 as opposed to those disposed towards lower end 46 of back wall 18. As noted above, car seat 12 does not include any support system or apparatus for the child's head 48 or any other way of preventing the child's head 48 from swinging around forward (away from the back wall 18) or from side to side inside the seating area 30 of car seat 12, which motion is known to be uncomfortable and which can possibly cause soreness or injury to the child 14.

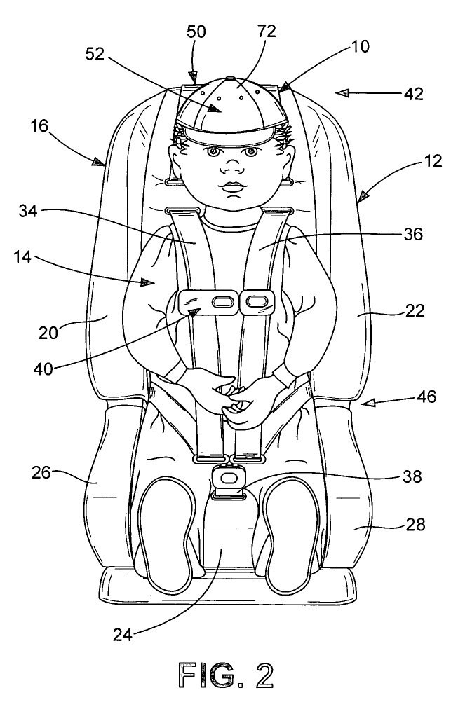

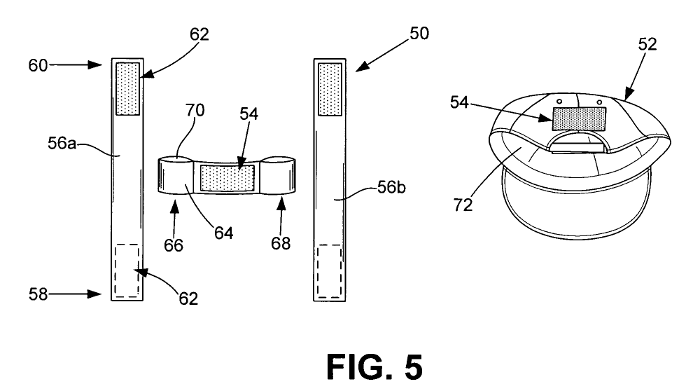

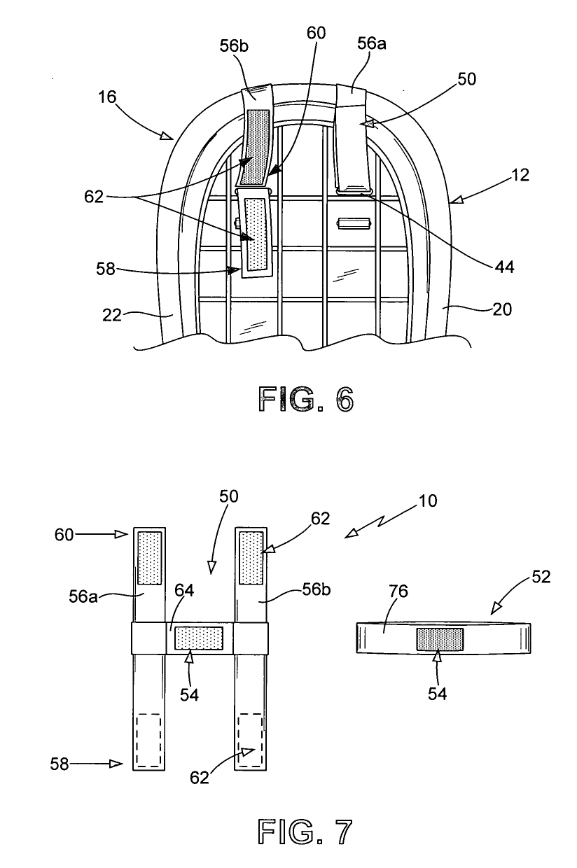

The head support apparatus 10 of the present invention is configured to be utilized with the car seat 12 to support the child's head 48 in a manner that generally prevents the head 48 from swinging around in car seat 12 and, thereby, reduces or substantially eliminates discomfort and soreness for child 14. In a preferred configuration, best shown in FIGS. 2, 3 and 5, head support apparatus 10 generally comprises a harness assembly 50 that secures the apparatus 10 to car seat 12, a head device 52 which attaches to the head 48 of child 14 and an attachment means 54 for removably attaching the head device 52 to the harness assembly 50. The harness assembly 50 comprises one or more elongated longitudinal strap members 56, shown as 56a and 56b in the figures, that are configured to sufficiently engage the body portion 16 of car seat 12 to secure head support apparatus to car seat 12. As best shown in FIG. 5, in a preferred embodiment the harness assembly 50 comprises a pair of longitudinal strap members 56a and 56b that are in spaced apart relation to each other. Each longitudinal strap member 56a/56b has a first end 58 and a second end 60 and is of sufficient length to extend over the upper end 42 of back wall 18 and through one pair of slots 44 such that the first ends 58 will connect to second end 60. As best shown in FIGS. 5 and 6, longitudinal strap members 56a/56b are provided with a connecting means 62 that allows the user to releasably connect the ends 58/60 together. In a preferred embodiment, each end 58/60 has one-half of the connecting means 62 and they are configured such that they cooperate with each other to connect first end 58 to second end 60 in a manner that allows the user to select the length of the longitudinal strap members 56a/56b to tightly secure them to body portion 16 of car seat 12. In the embodiment shown in the figures, the connecting means 62 is a hook-and-loop material such as Velcro®. Alternatively, snaps, buttons, ties and a variety of other types of connecting mechanisms can be utilized for connecting means 62. In an alternative embodiment, ends 58/60 of longitudinal strap members 56a/56b are fixedly connected together or the strap members 56a/56b are a single loop (no ends) such that the harness assembly 50 is sized for the particular car seat 12 and, typically, will be provided with car seat 12. Preferably, longitudinal strap members 56a/56b are made out of a partially elastic material to allow the child 14 the ability to comfortably move around, as opposed to be fixed against back wall 18 of body portion 16, in the seating area 30 of car seat 12 when he or she is not sleeping. However, the material should be sufficiently inelastic to prevent the undesired swinging the child's head 48 that is the objective of the apparatus 10 of the present invention.

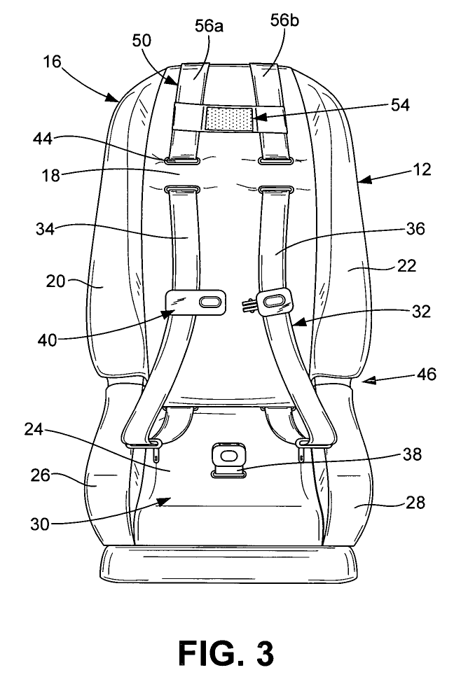

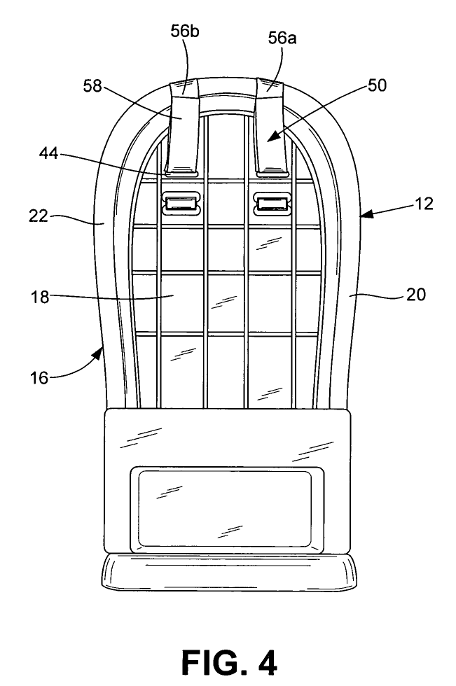

As shown in FIGS. 3 and 5, the preferred configuration of harness assembly 50 also comprises a lateral strap member 64 that interconnects the pair of spaced apart longitudinal strap members 56a/56b in a generally H-shaped configuration. Lateral strap member 64 is positioned on the harness assembly 50 such that it will be disposed on the front side of body portion 16 generally towards the upper end 42 of the back wall 18. In one embodiment, shown in FIG. 7, the first end 66 and second end 68 of strap member 64 are fixedly attached to longitudinal strap members 56a and 56b, respectively, utilizing a mechanism appropriate for the materials selected for the longitudinal 56a/56b and lateral 64 strap members. In the embodiment of FIG. 7, strap members 56a/56b and 64 are made out of a cloth material and are sewn together to form harness assembly 50. In a preferred embodiment of the present invention, however, the lateral strap member 64 is movably disposed along the length of longitudinal strap members 56a/56b so the user can place the lateral strap member 64 at a position along back wall 18 that is appropriate for the height of child 14 so the head device 52 can be beneficially positioned relative to the child's head 48. Being movable allows the user to move it down in the direction of the lower end 46 of back wall 18 for a relatively shorter child 14 or up in the direction of the upper end 42 of back wall 18 for a relatively taller child 14. Various movable mechanisms can utilized to allow the user to adjust the position of lateral strap member 64. For instance, ends 66/68 of lateral strap member 64 can have one half of a hook-and-loop connector and the outer facing surface of the longitudinal strap members 56a/56b can have the other half of the connector. Alternatively, a variety of snap, button, tie or other mechanisms can be utilized. A likely disadvantage of such mechanisms is that they may be uncomfortable for the child 14 to lean or lay against. As a result, in the preferred embodiment, the movable mechanism (shown as 70 in FIG. 5) is the use of a loop at each of the ends 66/68 of the lateral strap member 64 that is configured to allow the ends 66/68 of lateral strap member 64 to slidably engage longitudinal strap members 56a/56b. Preferably, the loops are sized and shaped to relatively tightly engage the longitudinal strap members 56a/56b so they will substantially stay in place when positioned by the user. As set forth in more detail below, the preferred positioning is to align the portion of the attachment means 54 on lateral strap member 64 with the portion of the attachment means 54 on the head device 52 that is worn on the head 48 of child 14 when he or she is sitting in car seat 12. If desired, lateral strap member 64 is made out of the same material as the longitudinal strap members 56a/56b. Alternatively, the lateral strap member 64 can be made out of an elastic material and the longitudinal strap members 56a/56b out of an inelastic material or the lateral strap member 64 can be made out of an inelastic material and the longitudinal strap members 56a/56b out of a generally elastic material.

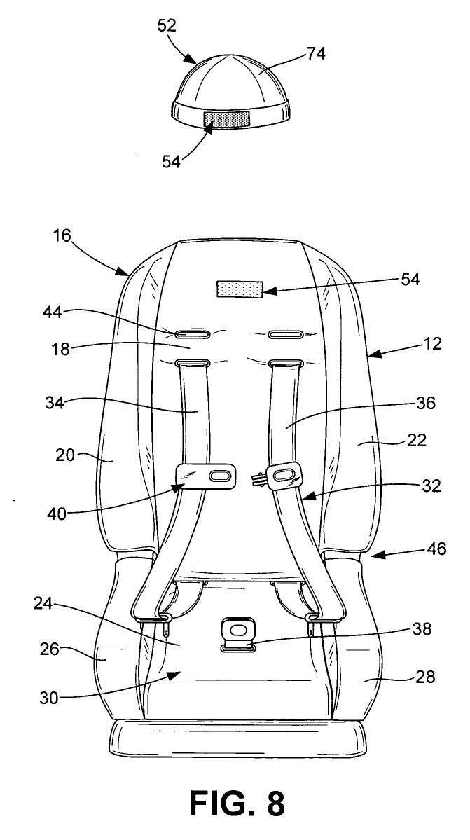

The head device 52 of the head support apparatus 10 of the present invention is configured to be secured onto or around the head 48 of the child 14 sitting in car seat 12 and, in the preferred embodiment, to attach to the harness assembly 50, which is secured to the body portion 12 of car seat 12. Head device 52 can be a variety of different devices that can be secured onto or around the child's head 48. The head device 52 should be sized and configured to fit onto the child's head 48, as shown in FIG. 2, or around the child's head. In a preferred embodiment, the head device 52 is a hat 72, such as the baseball-type hat shown in FIGS. 2 and 5, that fits onto the child's head 48. Alternatively, the head device 52 can be a beanie 74 ( as shown in FIG. 8) or other hat 72 that fits onto the child's head 48 or a headband 76 (as shown in FIG. 7) or the like that fits around the child's head 48. Although the head device 52 can be fixedly sized for the child's head 48, preferably the head device 52 is adjustable so that it can be utilized for the child 14 as he or she grows or be utilized for different sized children. In a preferred embodiment, the hat 72 is of the type having an adjustable rear band that utilizes a hook-and-loop connector to adjust the size. This type of connector is known to be generally softer to lay against than other types of connectors. Alternatively, the hat 72 or other head device 52 can have an adjustable rear band that utilizes snaps, buttons, ties or the like to secure the head device 52 on the child's head 48. In another alternative configuration, the head device 52 can be a hat 72 that has an elastic adjusting band or be a beanie 74 or headband 76 which is made out of an elastic material that stretches over the child's head 48. Virtually any type of hat, hat-like or headband-like object that can be worn by child 14 may be suitable for use or adaptable for use with the head support apparatus 10 of the present invention.

One of the advantages of the head support apparatus 10 of the present invention is that head device 52 can be customized by the user as he or she desires. For instance, the user can purchase or otherwise supply a hat 72, headband 74 or other head device 52 that is of a certain color or design, has a sports logo, product trademark or other design device thereon, has the name of the child 14 on it or a combination of these features. A wide variety of possible customization attributes can be applied to the head device 52 or be purchased to be used with the head support apparatus 10. Another advantage of the head support apparatus 10 is that the head device 52 can be easily removed from the harness assembly 50 or, if desired, replaced with a new head device 52. This allows the user to clean or replace a head device 52 that is dirty from use and replace the head device 52 if the child has outgrown it or if a different color, design or logo is desired (i.e., a sports logo or other design depending on the time of year). In the preferred embodiment, the harness assembly 50 is also easy to remove from car seat 12 and made out of a material that can be cleaned when necessary or, if desired, relatively inexpensively replaced. In a preferred embodiment, the components of the head support apparatus 10, namely the harness assembly 50, head device 52 and attachment means 54 are made out of materials and utilizing processes, both of which are well known in the art, that results in a relatively inexpensive head support apparatus 10.

As stated above, the attachment means 54 is configured to attach the head device 52 to the harness assembly 50, preferably to the lateral strap member 64. Although the head device 52 can be fixedly attached to the harness assembly 50, it is preferred that the head device 52 be removably attached to the harness assembly 50 to allow the user to remove head device 52 for cleaning or replacement, as described above. In the preferred embodiment of head support apparatus 10, the attachment means 54 is a hook-and-loop material, with half of the attachment mechanism attached to the harness assembly 50 (e.g., the lateral strap member 64) and the other half attached to the head device 52. As stated above, this type of attachment mechanism is generally softer to lean against than many other types of removable attachment means 54, including snaps, buttons and the like. If desired, however, snaps, buttons, ties or other known attachment mechanisms can be utilized for attachment means 54. Preferably, attachment means 54 is of the type that is easy to operate and suitable for washing, thereby allowing the user to remove the entire apparatus 10, including harness assembly 50, from the car seat 12 when cleaning is desired. The attachment means 54 utilized with apparatus 10 must be of sufficient strength to hold the child's head 48 generally in place when the child 14 is asleep in the car seat 12 in order to prevent the child's head 48 from swinging forward and side to side as the vehicle moves.

To utilize head support apparatus 10, the user first secures the harness assembly 50 of the preferred embodiment to the car seat 12 by placing one end 58 or 60 of one longitudinal strap member, such as 56a, through a slot 44 in the back wall 18 and the other longitudinal strap member, such as 56b, through the other slot in back wall 18. In one embodiment of the car seat 12, the body portion 16 has a pair of slots 44 that are not being utilized for the shoulder straps 34/36 and the longitudinal strap members 56a/56b are threaded through those slots 44. In another embodiment of car seat 12, having only one pair of slots 44 or only slots 44 that are being used for the shoulder straps 34/36 or other straps, the longitudinal strap members 56a/56b will have to share the same slot 44 as shoulder straps 34/36 or the other straps. The user then joins the ends 58/60 of each longitudinal strap member 56a and 56b together, as best shown in FIG. 6, to secure the harness assembly 50 to the car seat 12 with the attachment means 54 extending in the proper direction (typically away from back wall 18). The lateral strap member 64 is then moved up or down the longitudinal strap members 56a/56b to position the attachment means 54 generally behind where the child's head 48 will be when he or she is sitting in car seat 12. The child 14 is then placed in the seating area 30 of the car seat 12 and the hat 72, beanie 74, headband 76 or other head device 52 is placed on or around the child's head 48, as would be normal for such a head device 52. The portion of attachment means 54 on the head device 52 is then joined to the portion of attachment means 54 on the lateral strap member 64 to removably attach the head device 52 to harness assembly 50, thereby effectively securing the child's head 48 to the car seat 12. As the vehicle moves, the child's head 48 will not loosely swing forward and/or side to side and cause the child 14 soreness or injury, particularly when the child 14 is asleep in car seat 12. Preferably, the apparatus 10 is configured to allow the child 14 freedom to move his or her head 48 around while not asleep so the child 14 does feel unduly constrained in the car seat 12.

In an alternative embodiment, the head support apparatus 10 can comprise just the head device 52 and attachment means 54, with the attachment means 54 being configured to interconnect the head device 52 and the car seat 12. As shown in FIG. 8, one-half of the attachment means 54 is mounted directly to the car seat 12 instead of utilizing harness assembly 50 and the other half of mounting means 54 is mounted to the back side of the head device 52. In this embodiment, the mounting means 54 on the car seat 12 is mounted to the body portion 16, such as at back wall 18, or to the cushioned cover which is typically placed over the body portion 16 of car seat 12. If attached to the cover over the body portion 16, the mounting means 54 can be sewn, safety pinned, glued or attached by other mechanisms that are well known in the art to mount attachment means 54 to the cloth or cloth-like material typically utilized for car seat covers. Other than no harness assembly 50, the features and uses of this embodiment can be the same as described above. If harness assembly 50 is utilized, the longitudinal strap members 56a/56b can be configured to secure to the car seat 12 in a manner other than shown in the figures. For instance, the longitudinal strap members 56a/56b can be configured to secure to or go around the upper side walls 20/22 or attach to the cover over body portion 16 of car seat 12. Other configurations are also possible.

While there are shown and described herein specific forms of the invention, it will be readily apparent to those skilled in the art that the invention is not so limited, but is susceptible to various modifications and rearrangements in design and materials without departing from the spirit and scope of the invention. In particular, it should be noted that the present invention is subject to various modification with regard to any dimensional relationships set forth herein and modifications in assembly, materials, size, shape and use. For instance, there are numerous components described herein that can be replaced with equivalent functioning components to accomplish the objectives of the present invention.

What is claimed is:

1. A head support apparatus for use with a child car seat having a body portion configured to support a child in said car seat, said head support apparatus comprising:
a head device sized and configured to be received on the head of the child; and
means for attaching said head device to said car seat so as to prevent the head of the child from swinging loosely in said car seat.

2. The head support apparatus according to claim 1, wherein said head device is selected from the group consisting of a hat, a beanie and a headband.

3. The head support apparatus according to claim 1, wherein said attaching means is configured removably mount said head device to said car seat.

4. The head support apparatus according to claim 3, wherein said attaching means comprises a hook-and-loop mechanism.

5. The head support apparatus according to claim 1, wherein said attaching means interconnects said head device with a back wall of said body portion of said car seat.

6. The head support apparatus according to claim 1 further comprising a harness assembly configured to secure said apparatus to said car seat, said attaching means interconnecting said harness assembly and said head device.

7. The head support apparatus according to claim 6, wherein said harness assembly is configured to engage said body portion of said car seat.

8. The head support apparatus according to claim 6, wherein said harness assembly comprises one or more strap members.

9. The head support apparatus according to claim 8, wherein said one or more strap members comprises a pair of spaced apart longitudinal strap members and a lateral strap member interconnecting said longitudinal strap members.

10. The head support apparatus according to claim 9, wherein said lateral strap member is movably connected to each of said longitudinal strap members and said attaching means interconnects said head device with said lateral strap member.

11. The head support apparatus according to claim 10, wherein said lateral strap member comprises a loop at each of a first end and a second end of said lateral strap member, each of said loops sized and configured to receive one of said pair of longitudinal strap members therein.

12. A head support apparatus for use with a child car seat having a body portion configured to support a child in said car seat, said head support apparatus comprising:
a head device sized and configured to be received on the head of the child;
a harness assembly configured to secure said apparatus to said car seat, said harness assembly comprising one or more strap members sized and configured to secure said apparatus to said body portion of said car seat; and
means for attaching said head device to said harness assembly so as to prevent the head of the child from swinging loosely in said car seat.

13. The head support apparatus according to claim 12, wherein said attaching means is configured removably mount said head device to said harness assembly.

14. The head support apparatus according to claim 12, wherein said head device is selected from the group consisting of a hat, a beanie and a headband.

15. The head support apparatus according to claim 12, wherein said one or more strap members comprises a pair of spaced apart longitudinal strap members and a lateral strap member interconnecting said longitudinal strap members, said attaching means connecting said head device with said lateral strap member.

16. The head support apparatus according to claim 15, wherein said longitudinal strap members are configured to be received through a pair of slots in a back wall of said body portion of said car seat.

17. The head support apparatus according to claim 15, wherein said lateral strap member is movably connected to each of said longitudinal strap members.

18. The head support apparatus according to claim 17, wherein said lateral strap member comprises a loop at each of a first end and a second end of said lateral strap member, each of said loops sized and configured to receive one of said pair of longitudinal strap members therein.

19. A head support apparatus for use with a child car seat having a body portion configured to support a child in the car seat, said head support apparatus comprising:
a head device sized and configured to be received on the head of the child, said head device selected from the group consisting of a hat, a beanie and a headband;
a harness assembly configured to secure said apparatus to said car seat, said harness assembly comprising one or more strap members sized and configured to secure said apparatus to said body portion of said car seat; and
means for removably attaching said head device to said harness assembly so as to prevent the head of the child from swinging loosely in said car seat.

20. The head support apparatus according to claim 19, wherein said one or more strap members comprises a pair of spaced apart longitudinal strap members and a lateral strap member movably connected to each of said longitudinal strap members, said attaching means interconnecting said head device with said lateral strap member.
